(19) United States
(12) Patent Application Publication
(10) Pub. No.: US 2019/0015297 A1
(43) Pub. Date: Jan. 17, 2019

(54) DRUG-FILLED SYNTHETIC RESIN AMPULE

(71) Applicant: TERUMO KABUSHIKI KAISHA, Tokyo (JP)

(72) Inventors: Naomi HARADA, Hadano-shi (JP); Seiji YAGO, Sagamihara-shi (JP); Hideka KIKUCHI, Isehara-shi (JP)

(73) Assignee: TERUMO KABUSHIKI KAISHA, Tokyo (JP)

(21) Appl. No.: 16/133,481

(22) Filed: Sep. 17, 2018

Related U.S. Application Data
(63) Continuation of application No. PCT/JP2017/010807, filed on Mar. 16, 2017.

(30) Foreign Application Priority Data
Mar. 18, 2016 (JP) 2016-056243

(51) Int. Cl. A61J 1/06; A61J 1/14

(52) U.S. Cl. CPC A61J 1/067; A61J 1/1468

(57) ABSTRACT

A drug-filled synthetic resin ampule 1m includes an ampule main body 2m and a drug stored in the ampule main body. The ampule main body includes a distal end portion, a hollow portion having a drug storing portion, and an annular breakable portion provided between a lower portion of the distal end portion and an upper portion of the hollow portion. The ampule main body includes no inner lateral surface protrusion on an inner lateral portion thereof which is located on a side toward the distal end portion with respect to the annular breakable portion. The distal end portion is configured such that an inner top surface of the distal end portion is located near a plane defined by the annular breakable portion and an inner surface of the distal end portion is a low-drug-retention surface.

### CROSS-REFERENCE TO RELATED APPLICATIONS

This is a bypass continuation of PCT Application No. PCT/JP2017/010807, filed on Mar. 16, 2017, which claims priority to Japanese Application No. 2016-056243, filed on Mar. 18, 2016. The contents of these applications are hereby incorporated by reference in their entireties.

### BACKGROUND

The present disclosure relates to a drug-filled synthetic resin ampule which is opened by a breaking operation.

In recent years, in place of glass containers, synthetic resin ampules have been used as containers for containing drugs from the viewpoint of safety against breakage of a container as a result of falling, injury when a container is opened, generation of fragments, etc., as well as from the viewpoint of ease of handling.

A synthetic resin ampule is disclosed in JP 2014-69856 A. The synthetic resin ampule container of JP 2014-69856 A includes a main body portion (1) formed, by biaxial stretch blow molding, into the shape of a tube with a bottom and containing an internal solution (N), a head portion (6) which has the shape of a tube with a top and which is continuously provided to extend vertically from the upper end of the main body portion (1), and a weakened portion (10) which is formed at the boundary between the main body portion (1) and the head portion (6) and which is broken as a result of relative displacement of the main body portion (1) and the head portion (6). A large number of longitudinal ribs (9) are provided on an inner circumferential surface portion (7) to which the peripheral edge of the lower end liquid surface (n1) of a residual internal solution (n) located within the head portion (6) adheres. The longitudinal ribs (9) are juxtaposed along the circumferential direction so as to form an uneven surface portion (8). The uneven surface portion (8) is formed by mixedly forming the longitudinal ribs (9) whose upper ends differ in height position.

Another synthetic resin ampule is disclosed in, for example, JP 2013-095436 A. The synthetic resin ampule of JP 2013-095436 A is a plastic ampule 1 which includes an ampule main body 3 having a spout 8, a stopper portion 5 which is communicatably connected to the ampule main body 3 through a neck portion 4 formed along the spout 8, and a head portion 7 which is connected to the stopper portion 5 through a thin plate-shape edge portion 6 projecting outward from the stopper portion 5, wherein the head portion 7 has an arm plate 15 which is flat in a direction intersecting the edge portion 6. A user pinches the arm plate 15 with his/her fingers and pulls the arm plate 15 upward so as to bend the ampule at a position between the ampule main body 3 and the head portion 7, while using the neck portion 4 as a fulcrum, thereby cutting and breaking the neck portion 4 to open the ampule.

### SUMMARY

Since the synthetic resin ampules of JP 2014-69856 A and JP 2013-095436 A are made of synthetic resin, the ampules do not break even when they fall down and are easily handled.

However, in the ampule of JP 2014-69856 A, since the head portion (6) is hollow and communicates with the ampule main body, when the ampule is inclined and is then returned to an upright posture, the drug may remain in the head portion.

In the ampule of JP 2013-095436 A, since the drug holding space of the head portion 7 is small, even when the ampule is brought into an inclined state, the amount of the drug remaining within the stopper portion 5 of the head portion 7 is smaller as compared with the ampule of JP 2014-69856 A. In the case of the ampule of JP 2013-095436 A, a user pinches the arm plate 15 with his/her fingers and pulls the arm plate 15 upward for bending at a position between the ampule main body 3 and the head portion 7, while using the neck portion 4 as a fulcrum, thereby cutting and breaking the neck portion 4 to open the ampule. However, since the neck portion 4 is a small diameter portion, an annular space which is greater in diameter than the neck portion 4 is formed in an upper portion of the broken neck portion 4 and a peripheral edge portion of the stopper portion 5. Therefore, the drug is highly likely to remain in the annular space.

In view of the forgoing, an object of the present disclosure is to provide a drug-filled synthetic resin ampule which includes a distal end portion, a hollow portion having a drug storing portion, and an annular breakable portion provided between a lower portion of the distal end portion and an upper portion of the hollow portion and which contains a drug, wherein, when the ampule is opened as a result of the annular breakable portion being broken, only a very small amount of the drug remains in the distal end portion.

In one embodiment, a drug-filled synthetic resin ampule comprises an ampule main body and a drug stored in the ampule main body; wherein the ampule main body includes a distal end portion, a hollow portion having a drug storing portion, and an annular breakable portion provided between a lower portion of the distal end portion and an upper portion of the hollow portion; the ampule main body includes no inner lateral surface protrusion on an inner lateral portion thereof which is located on a side toward the distal end portion with respect to the annular breakable portion; and the distal end portion is configured such that an inner top surface of the distal end portion is located near a plane defined by the annular breakable portion and an inner surface of the distal end portion is a low-drug-retention surface.

In another embodiment, a drug-filled synthetic resin ampule comprises an ampule main body and a drug stored in the ampule main body; wherein the ampule main body includes a distal end portion, a hollow portion having a drug storing portion, and an annular breakable portion provided between a lower portion of the distal end portion and an upper portion of the hollow portion; and the distal end portion is configured such that an inner top surface of the distal end portion is located near a plane defined by the annular breakable portion, the inner top surface has a flat surface, the ample main body includes ribs which are formed on its inner lateral portion located on a side toward the distal end portion with respect to the annular breakable portion, and an inner surface of the distal end portion is a low-drug-retention surface.

### BRIEF DESCRIPTION OF THE DRAWINGS

FIG. 1 is a front view of a drug-filled synthetic resin ampule of one embodiment of the present disclosure.

FIG. 2 is a plan view of the drug-filled synthetic resin ampule of FIG. 1.

FIG. 3 is a left side view of the drug-filled synthetic resin ampule of FIG. 1.

FIG. 4 is a sectional view taken along line A-A of FIG. 1.

FIG. 5 is an enlarged sectional view of a breakable portion and its vicinity of the synthetic resin ampule shown in FIG. 4.

FIG. 6 is an enlarged sectional view of a breakable portion and its vicinity of a drug-filled synthetic resin ampule of another embodiment of the present disclosure.

FIG. 7 is an enlarged sectional view of a breakable portion and its vicinity of a drug-filled synthetic resin ampule of another embodiment of the present disclosure.

FIG. 8 is an enlarged sectional view of a breakable portion and its vicinity of a drug-filled synthetic resin ampule of another embodiment of the present disclosure.

FIG. 9 is an enlarged sectional view of a breakable portion and its vicinity of a drug-filled synthetic resin ampule of another embodiment of the present disclosure.

FIG. 10 is an enlarged sectional view of a breakable portion and its vicinity of a drug-filled synthetic resin ampule of another embodiment of the present disclosure.

FIG. 11 is an enlarged sectional view of a breakable portion and its vicinity of a drug-filled synthetic resin ampule of another embodiment of the present disclosure.

FIG. 12 is an enlarged sectional view of a breakable portion and its vicinity of a drug-filled synthetic resin ampule of another embodiment of the present disclosure.

FIG. 13 is an enlarged sectional view of a breakable portion and its vicinity of a drug-filled synthetic resin ampule of another embodiment of the present disclosure.

FIG. 14 is an enlarged sectional view of a breakable portion and its vicinity of a drug-filled synthetic resin ampule of another embodiment of the present disclosure.

FIG. 15 is an enlarged sectional view of a breakable portion and its vicinity of a drug-filled synthetic resin ampule of another embodiment of the present disclosure.

FIG. 16 is a longitudinal sectional view of a drug-filled synthetic resin ampule of another embodiment of the present disclosure.

FIG. 17 is a longitudinal sectional view of a drug-filled synthetic resin ampule of another embodiment of the present disclosure.

FIG. 18 is an enlarged sectional view of a breakable portion and its vicinity of the synthetic resin ampule shown in FIG. 17.

FIG. 19 is a longitudinal sectional view of a drug-filled synthetic resin ampule of another embodiment of the present disclosure.

FIG. 20 is an enlarged sectional view of a breakable portion and its vicinity of the synthetic resin ampule shown in FIG. 19.

### DETAILED DESCRIPTION

Embodiments of the present disclosure will now be described in detail with reference the accompanying drawings.

A drug-filled synthetic resin ampule 1 of the present disclosure includes an ampule main body 2 and a drug 6 stored in the ampule main body 2. The ampule main body 2 includes a distal end portion 3, a hollow portion 21 having a drug storing portion 23, and an annular breakable portion 5 provided between a lower portion of the distal end portion 3 and an upper portion of the hollow portion 21. The ampule main body 2 has no inner lateral surface protrusion (inner side surface protrusion) on its inner lateral portion (inner side portion) on the distal end portion side with respect to the annular breakable portion 5. The distal end portion 3 is configured such that an inner top surface of the distal end portion 3 is located near a plane defined by the annular breakable portion 5, and the inner surface of the distal end portion is a low-drug-retention surface.

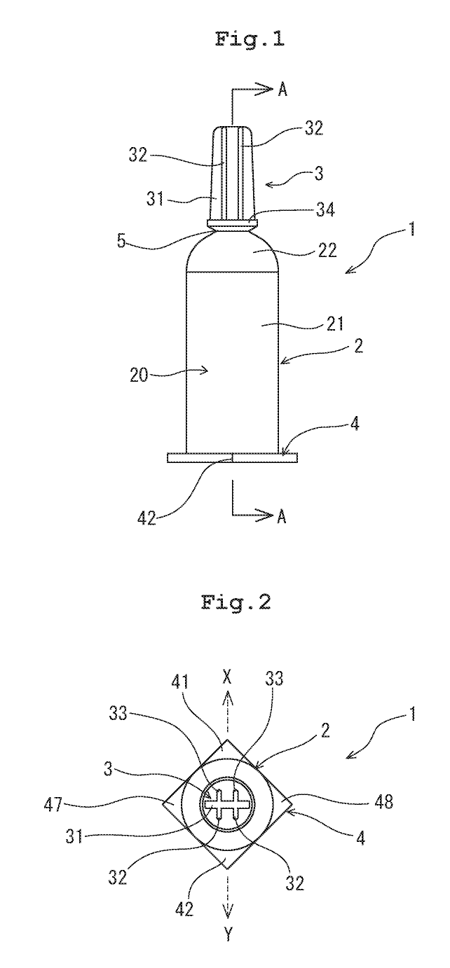

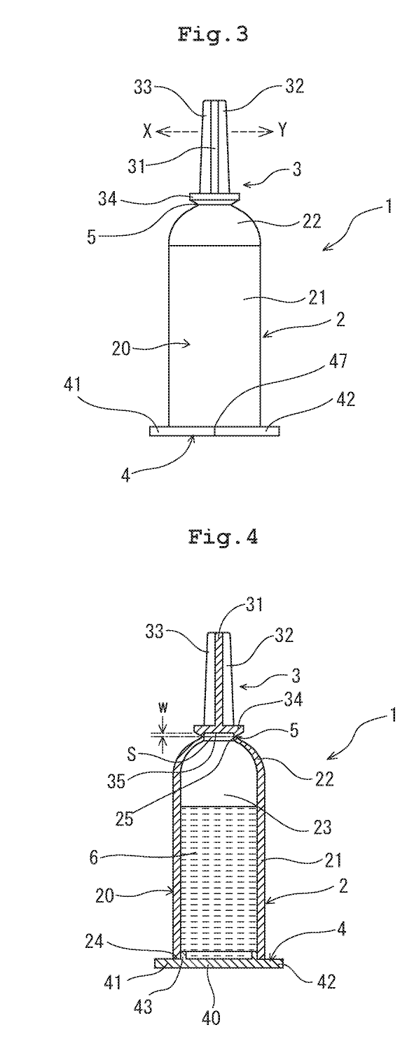

As shown in FIGS. 1 to 4, the drug-filled synthetic resin ampule 1 of the present disclosure includes the ampule main body 2 and the drug 6 stored in the ampule main body 2.

As shown in FIGS. 1 to 4, the ampule main body 2 is self-standing. The ampule main body 2 includes the distal end portion 3 which is located on the upper side when the ampule main body 2 is in a free-standing state; the hollow portion 21 having the drug storing portion 23; and the annular breakable portion 5 provided between the lower portion of the distal end portion 3 and the upper portion of the hollow portion 21. In the ampule 1 of this embodiment, the self-standing ampule main body 2 includes a tubular body 20 and a bottom plate member 40 which seals a lower end opening of the tubular body 20. The tubular body 20 includes the hollow portion 21, the distal end portion 3, and the breakable portion 5.

The tubular body 20 includes the hollow portion 21 having a lower end opening and extending upward; the distal end portion 3 located above the hollow portion; and the breakable portion 5 which is provided between the lower portion of the distal end portion 3 and the upper portion of the hollow portion 21; in other words, provided to form a boundary between the distal end portion 3 and the hollow portion 21. The hollow portion 21 has the drug storing portion 23. Preferably, the drug storing portion 23 has a volume of about 0.5 to 50 ml. As shown in FIG. 4, the hollow portion 21 has a cylindrical portion which extends over a predetermined length while maintaining approximately constant outer and inner diameters, and an inner surface tapered portion 22 located at an upper portion of the cylindrical portion. Therefore, in the ampule 1 of this embodiment, the hollow portion 21 has the inner surface tapered portion 22 whose diameter decreases toward the breakable portion 5. Notably, the tapered portion 22 may be a tapered portion in which the diameters of both the inner and outer surfaces thereof decrease toward an upper portion thereof.

The tubular body 20 can be molded by injection molding. For example, after the tubular main body portion including the hollow portion 21 is molded by injection molding, the breakable portion 5 may be attached thereto by ultrasonic welding or high-frequency welding. Alternatively, the entire tubular body 20 including the breakable portion 5 may be formed by injection molding. The bottom surface portion 4 may be integrally molded when the tubular body 20 or the tubular main body portion including the hollow portion 21 is molded. Alternatively, like the breakable portion 5, the bottom surface portion 4 may be attached to the tubular body 20 later on by, for example, ultrasonic welding or high-frequency welding.

The inner diameter of the cylindrical portion is preferably 6 to 33 mm, particularly preferably 7 to 24 mm. The outer diameter of the cylindrical portion is preferably 7 to 35 mm, particularly preferably 10 to 25 mm. The inner diameter of the tapered portion 22 at a small diameter portion thereof is preferably 3 to 12 mm, particularly preferably 3 to 9 mm.

Preferably, the hollow portion (the drug storing portion 23) of the tubular body 20 is formed to be transparent so that the stored drug can be visually observed. The internal pressure of the drug storing portion 23 of the tubular body 20 may be the normal pressure. Alternatively, the drug storing portion 23 may be brought into a pressure reduced or vacuum state. In the case where the drug storing portion is in a pressure reduced or vacuum state, the effect of preventing degeneration, decomposition, degradation, etc. of the drug is improved.

The stored drug 6 is a liquid drug. Examples of the drug include an analgesic (e.g., morphine (narcotic analgesic)), insulin, an antitumor drug, a cardiotonic, an intravenous anesthetic, an antiparkinsonian drug, an antiulcer drug, a corticosteroid, an antiarrhythmic drug, an electrolyte replenisher, an antiviral drug, an immunostimulant, an antibiotic, a local anesthetic (e.g., Xylocaine), a vitamin, a comprehensive vitamin, various amino acid, and an antithrombotic drug (e.g., heparin). Particularly preferred is a drug that needs careful handling and management, such as a narcotic analgesic or an antitumor drug.

The breakable portion 5 is a thin-wall weak portion provided in the vicinity of the boundary between the drug storing portion 23 and the distal end portion 3. In this embodiment, the thin-wall weak portion (breakable portion) is formed by an annular groove formed on the outer surface of the tubular body 20. Specifically, the annular groove is formed on the outer surface of an upper end portion of the tapered portion 22 of the tubular body 20. When the distal end portion 3 is bent in relation to the tubular body 20, the ampule is broken at the breakable portion 5, whereby the drug storing portion 23 is opened. The groove forming portion has a V-shaped cross section. Specifically, the angle of the letter V of the cross section of the groove forming portion is preferably 30 to 90°, particularly preferably 40 to 50°. In the case where the groove forming portion is formed to have such an angle, when the distal end portion 3 is bent, stress concentrates at the center of the breakable portion, so that breakage occurs without fail.

The groove forming portion may have any shape so long as it is easily broken. The shape of the groove forming portion is not limited to the V-like shape employed in the embodiment and may be a semi-circular shape, a semi-elliptical shape, or the like shape. Also, the thickness of the groove forming portion may be rendered smaller than that of a portion in the vicinity of the groove forming portion so as to facilitate the breakage of the breakable portion. Alternatively, the breakable portion may be made of a material weaker than the material of the remaining portion. Specifically, it is preferred to employ multicolor molding so as to form only the breakable portion and its vicinity into an annular shape using a material which breaks easily, and to form the remaining portion using a material which does not break easily. In the embodiment of the present disclosure, the groove forming portion is an annular groove forming portion and is provided continuously on the entire circumference of the outer circumferential surface of the drug storing portion. However, the groove forming portion may be provided intermittently.

An edge portion of the annular groove forming portion, which forms the breakable portion 5, on the side toward the tapered portion and an edge portion of the annular groove forming portion on the side toward the distal end portion may be chamfered. Specifically, the outer edge portion on the tapered portion side and the outer edge portion on the distal end side may be rounded.

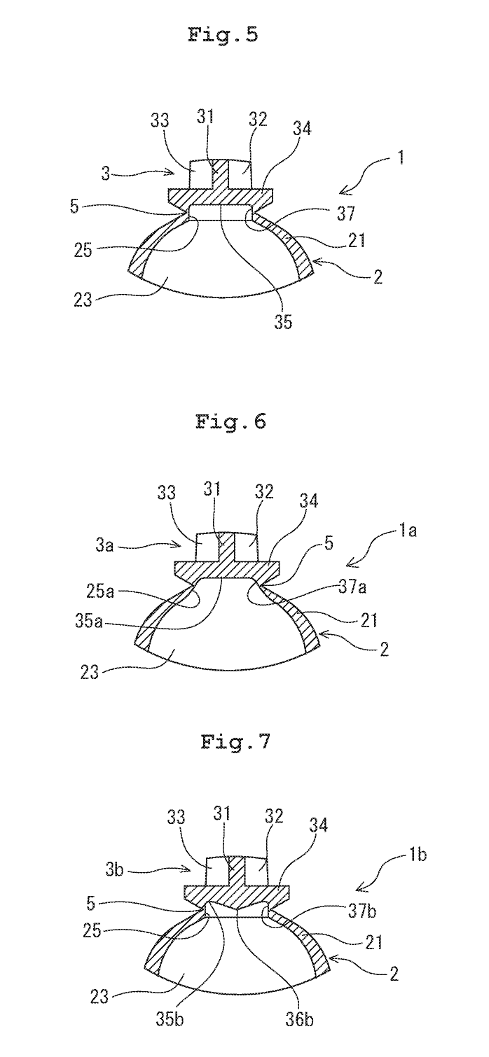

The distal end portion 3 forms an upper portion of the ampule main body 2 and is located above the tubular body 20. As shown in FIGS. 4 and 5, the distal end portion 3 has the inner top surface 35. The inner top surface 35 of the distal end portion 3 is located near the plane S defined by the annular breakable portion 5. In the ampule 1 of this embodiment, the plane S defined by the annular breakable portion 5 and the inner top surface 35 of the distal end portion 3 are spaced from each other by a predetermined distance W. Preferably, the distance W is as close to 0 mm as possible.

The ampule main body 2; specifically, the distal end portion 3, has no inner lateral surface protrusion on its inner lateral portion on the distal end portion side (the top surface side) with respect to the annular breakable portion 5. In particular, in the ampule of this embodiment, as shown in FIG. 5, a lower inner portion (inner lateral portion) 37 of the distal end portion 3 has a short hollow portion which extends from the inner surface of the annular breakable portion 5 to a corner portion of the inner top surface 35 while maintaining an approximately constant inner diameter.

In particular, in the ampule 1 of this embodiment, a short small-diameter mouth portion 25 is also provided at the upper portion of the hollow portion 21. The mouth portion 25 extends from the inner surface of the annular breakable portion 5 toward a lower portion of the hollow portion 21 while maintaining an approximately constant inner diameter. In the ampule of this embodiment, the inner lateral portion 37 of the ampule 1 has an approximately constant inner diameter in a region from the mouth portion 25 of the hollow portion 21 to the inner top surface 35 of the distal end portion 3. As shown in FIG. 5, the corner portion of the inner top surface 35 of the distal end portion 3 has a curved surface having no edge. The distal end portion 3 is solid in a region above the inner top surface 35. Notably, the distal end portion 3 may have a cavity.

Notably, as in the case of an ampule la of an embodiment shown in FIG. 6, an inner lateral portion 37a extending from the inner surface of the annular breakable portion 5 to a corner portion of an inner top surface 35a may be a hollow portion whose diameter decreases toward the inner top surface 35a. This form of the distal end portion 3a may be applied to ampules of all embodiments which will be described later. In the ampule la of this embodiment, the inner surface of the upper portion of the hollow portion 21 has a mouth portion 25a whose diameter increases from the inner surface of the annular breakable portion 5 toward a lower portion of the hollow portion 21 (whose diameter decreases toward the inner top surface). This form of the hollow portion 21 may be applied to ampules of all the embodiments which will be described later.

The inner surface of the distal end portion 3 is a low-drug-retention surface. In the ampule 1 of this embodiment, since the inner top surface of the distal end portion 3 is flat, in cooperation with the above-described form of the side surface, the inner top surface provides a low-drug-retention surface. Preferably, the inner surface (the side surface and the top surface) of the distal end portion 3 is a water repellent surface. This restrains adhesion of the drug. The water repellent surface may be the inner surface of the distal end portion itself when the distal end portion is made of a resin having water repellency. Alternatively, the water repellent surface may be formed by providing a film of a water repellent substance on the inner surface of the distal end portion. The water-repellent film may be formed by coating the inner surface of the distal end portion with a water-repellent coating material and hardening the coating material.

The water-repellent film may be provided on the entire inner surface of the hollow portion 21, and further provided on the entire inner surface of the ampule main body 2, including the upper surface of the bottom surface portion 4, which will be described later.

The water-repellent film is preferably formed of, for example, a fluororesin, a silicone resin, or poly(p-xylylene).

The fluororesin is preferably, for example, an ethylene tetrafluoride-perfluoroethoxyethylene copolymer, polytetrafluoroethylene, a tetrafluoroethylene-perfluoroalkyl vinyl ether copolymer, or a tetrafluoroethylene-hexafluoropropylene copolymer.

The silicone resin is formed from a silicone compound, such as a dimethylsilicone compound or an alkoxysilane compound, more preferably a trialkoxysilane compound. The alkoxy group is generally a methoxy group or an ethoxy group. The group responsible for water repellency is selected from the group consisting of a methyl group and a fluoroalkyl group.

The poly(p-xylylene) used for forming the film is preferably one represented by the following chemical formula.

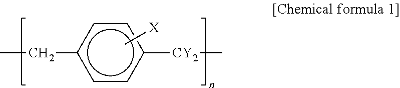

### (X: H, Cl or CH₃, Y: H or F)

The poly(p-xylylene) used in the present disclosure may be poly(p-xylylene) in which the aromatic ring is not substituted by a functional group or the aromatic ring or a methylene group is substituted by a functional group; for example, poly(chloro-p-xylylene) in which the aromatic ring is substituted by chlorine, poly(methyl-p-xylylene) in which the aromatic ring is substituted by a methyl group, or poly(fluoro-p-xylylene) in which a methylene group is substituted by fluorine. The poly(p-xylylene) used in the present disclosure may be a homopolymer consisting of any of the aforementioned types of poly(p-xylylene) or a copolymer of a p-xylylene monomer and a monomer copolymerizable therewith.

Particularly preferred is poly(p-xylylene) in which the aromatic ring is not substituted by a functional group, or poly(chloro-p-xylylene). The poly(p-xylylene) film may be formed of a single layer of any of the aforementioned types of poly(p-xylylene) or any of the aforementioned copolymers, or may be formed of multiple layers of any of the aforementioned types of poly(p-xylylene) and/or any of the aforementioned copolymers.

The term “poly(p-xylylene)” as used herein refers not only to poly(p-xylylene) in which the aromatic ring is not substituted by a functional group, but also to those represented by the aforementioned chemical formula 1.

The poly(p-xylylene) used in the present disclosure is preferably formed by polymerization of a p-xylylene monomer prepared through thermal decomposition of a p-xylylene dimer (i.e., a raw material) represented by the aforementioned chemical formula 1. The layered film formed of the poly(p-xylylene) does not generate pinholes and exhibits constant thickness. The poly(p-xylylene) film has a thickness of preferably 0.5 μm to 10 μm, particularly preferably 1 μm to 6 μm.

Also, as in ampules 1b to 1j shown in FIGS. 7 to 15, the distal end portion 3 may have a protruding portion which is provided at a central portion of the inner top surface and which protrudes in a direction toward the hollow portion (a direction toward a central portion of the bottom surface portion 4). When such a protruding portion is provided, the volume of the drug retainable portion of the distal end portion decreases. Also, before the ampule is opened, the drug adhering to the inner surface of the distal end portion is easily caused to drop into the hollow portion by applying a vibration to the distal end portion by, for example, tapping the distal end portion.

Since each of the ampules 1b to 1j shown in FIGS. 7 to 15 has the above-described protruding portion, the inner surface of the distal end portion serves as a low-drug-retention surface. Since the volume of the drug retainable portion of the distal end portion is sufficiently small, a portion of each ampule, which portion is located above the breakable portion and which contains the distal end portion, cannot retain the drug substantially. The protrusion height of the protruding portion from the inner bottom surface of the distal end portion is preferably determined such that the distance between the plane S and the apex of the protruding portion falls within a numerical range of 0 to 55% of the inner diameter of the opening portion. Furthermore, even in an ampule having such a protruding portion, the inner surface of the distal end portion, the entire inner surface of the hollow portion, and the entire inner surface of the ampule main body 2 including the upper surface of the bottom surface portion may be the water repellent surface as described above.

In the ampule 1b shown in FIG. 7, its distal end portion 3b has a protruding portion 36b which is provided at a central portion of an inner top surface 35b and which protrudes in a direction toward the hollow portion (a direction toward a central portion of the bottom surface portion 4). The protruding portion 36b is tapered such that its diameter decreases toward the apex thereof. The side surface of the protruding portion 36b extends approximately linearly toward the apex. The apex of the protruding portion 36b is located near the plane defined by the annular breakable portion 5. The protrusion height of the protruding portion 36b is relatively small. A peripheral edge portion of the inner top surface 35b has an annular flat surface. Also, the distal end portion 3b has an annular space which is defined by an inner lateral portion 37b, the inner top surface 35b, and the outer surface of the protruding portion 36b and whose diameter increases toward the lower side.

Also, in the distal end portion 3b of this embodiment, its lower inner portion (inner lateral portion) 37b has a short hollow portion which extends from the inner surface of the annular breakable portion 5 to a corner portion of the inner top surface 35b while maintaining an approximately constant inner diameter. As in the case of the above-described ampule 1, in the ampule 1b of this embodiment, a short small-diameter mouth portion 25 is also provided at the upper portion of the hollow portion 21. The mouth portion 25 extends from the inner surface of the annular breakable portion 5 toward a lower portion of the hollow portion 21 while maintaining an approximately constant inner diameter.

Therefore, in the ampule 1b of this embodiment, the inner lateral portion of the ampule 1b has an approximately constant inner diameter in a region from the mouth portion 25 of the hollow portion 21 to the inner top surface 35b of the distal end portion 3b. As shown in FIG. 7, the corner portion of the inner top surface 35b of the distal end portion 3b has a curved surface having no edge. The distal end portion 3b is solid in a region above the inner top surface 35b. Notably, the distal end portion 3b may have a cavity.

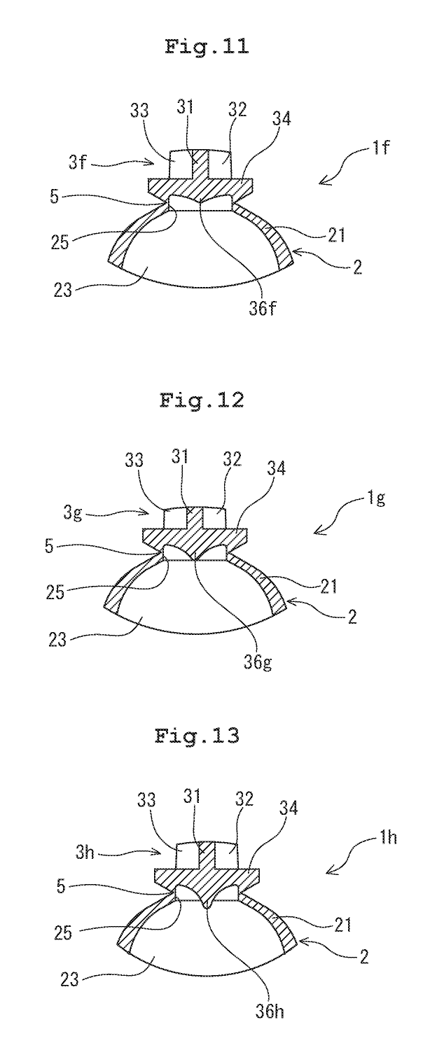

The shape of the outer surface of the protruding portion 36b is not limited to the above-described tapered shape for diameter reduction. For example, as in the case of a protruding portion 36f provided on a distal end portion 3f of the ampule lf shown in FIG. 11, the protruding portion may have a curved outer surface. In the protruding portion 36f of this embodiment, its outer surface is curved inward as compared with the tapered outer surface. Notably, the outer surface of the protruding portion may be curved in the opposite direction; i.e., may be curved outward (bulge) as compared with the tapered outer surface.

Also, the shape of the peripheral edge portion of the inner top surface is not limited to that of the peripheral edge portion having an annular flat surface as in the above-described ampule lb. For example, as in the ampule 1j shown in FIG. 15, the peripheral edge portion has a curved surface which is continuous with the inner lateral portion 37j of the distal end portion 3j of the ampule 1j and does not have an annular flat surface substantially.

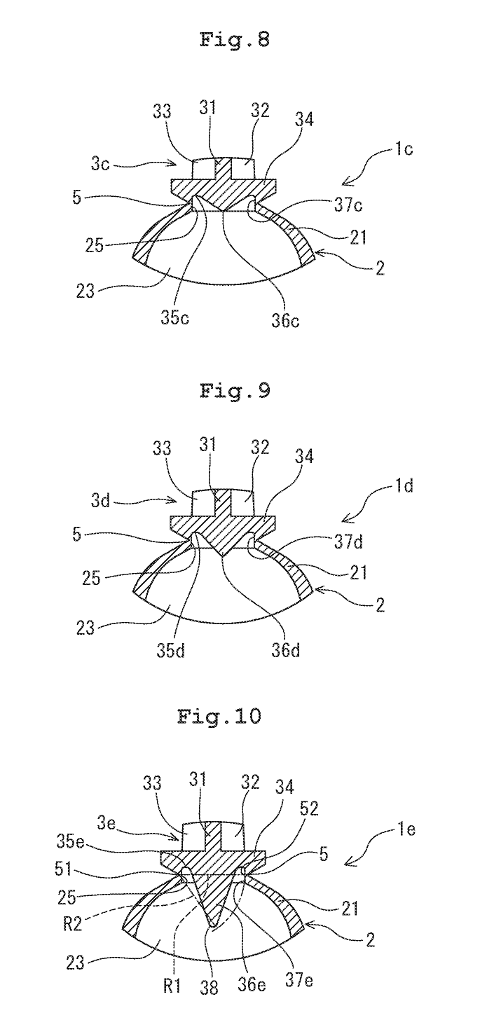

The basic form of the ampule 1c shown in FIG. 8 is the same as the above-described ampules 1 and 1b and differs therefrom only in the protrusion height of the protruding portion. Its distal end portion 3c has a protruding portion 36c which is provided at a central portion of an inner top surface 35c and which protrudes in a direction toward the hollow portion (a direction toward a central portion of the bottom surface portion 4). The protruding portion 36c is tapered such that its diameter decreases toward the apex thereof. The side surface of the protruding portion 36c extends approximately linearly toward the apex. The apex of the protruding portion 36c enters the hollow portion 21 beyond the plane defined by the annular breakable portion 5. Thus, the ampule 1c has a protruding portion having a protrusion height greater than that in the above-described ampule 1b.

In the ampule 1c of this embodiment, the apex of the protruding portion 36c is located within the small-diameter mouth portion 25 of the hollow portion 21 of the ampule 1c; specifically, located near the lower end of the mouth portion 25. A peripheral edge portion of the inner top surface 35c has an annular flat surface. Also, the distal end portion 3c has an annular space which is defined by an inner lateral portion 37c, the inner top surface 35c, and the outer surface of the protruding portion 36c and whose diameter increases toward the lower side.

The shape of the outer surface of the protruding portion 36c is not limited to the above-described tapered shape for diameter reduction. For example, as in the case of a protruding portion 36g provided on a distal end portion 3g of the ampule 1g shown in FIG. 12, the protruding portion may have a curved outer surface. In the protruding portion 36g of this embodiment, its outer surface is curved inward (slightly concaved) as compared with the tapered outer surface. Notably, the outer surface of the protruding portion may be curved in the opposite direction; i.e., may be curved outward (bulge) as compared with the tapered outer surface.

The basic form of the ampule 1d shown in FIG. 9 is the same as the above-described ampules 1 and 1b and differs therefrom only in the protrusion height of the protruding portion. Its distal end portion 3d has a protruding portion 36d which is provided at a central portion of an inner top surface 35d and which protrudes in a direction toward the hollow portion (a direction toward a central portion of the bottom surface portion 4). The protruding portion 36d is tapered such that its diameter decreases toward the apex thereof. The side surface of the protruding portion 36d extends approximately linearly toward the apex.

The apex of the protruding portion 36d enters the hollow portion 21 beyond the plane defined by the annular breakable portion 5. Thus, the ampule 1d has a protruding portion having a protrusion height greater than that in the above-described ampule 1c. In the ampule 1d of this embodiment, the apex of the protruding portion 36d is located beyond the small-diameter mouth portion 25 of the hollow portion 21 of the ampule ld; specifically, located in a region below the mouth portion 25 (an upper portion of the drug storing portion 23 of the hollow portion 21). A peripheral edge portion of the inner top surface 35d has an annular flat surface. Also, the distal end portion 3d has an annular space which is defined by an inner lateral portion 37d, the inner top surface 35d, and the outer surface of the protruding portion 36d and whose diameter increases toward the lower side.

The shape of the outer surface of the protruding portion 36d is not limited to the above-described tapered shape for diameter reduction. For example, as in the case of a protruding portion 36h provided on a distal end portion 3h of the ampule 1h shown in FIG. 13, the protruding portion may have a curved outer surface. In the protruding portion 36h of this embodiment, its outer surface is curved inward (slightly concaved) as compared with the tapered outer surface. Notably, the outer surface of the protruding portion may be curved in the opposite direction; i.e., may be curved outward (bulge) as compared with the tapered outer surface.

The basic form of the ampule 1e shown in FIG. 10 is the same as the above-described ampules 1 and 1b and differs therefrom only in the protrusion height of the protruding portion. Its distal end portion 3e has a protruding portion 36e which is provided at a central portion of an inner top surface 35e and which protrudes in a direction toward the hollow portion (a direction toward a central portion of the bottom surface portion 4). The protruding portion 36e is tapered such that its diameter decreases toward the apex thereof. The side surface of the protruding portion 36e extends approximately linearly toward the apex.

The apex of the protruding portion 36e enters the hollow portion 21 beyond the plane defined by the annular breakable portion 5. Thus, the ampule 1e has a protruding portion having a protrusion height greater than that in the above-described ampule 1d. In the ampule 1e of this embodiment, the apex of the protruding portion 36e is located beyond the small-diameter mouth portion 25 of the hollow portion 21 of the ampule 1e and a region below the mouth portion 25 (an upper portion of the drug storing portion 23 of the hollow portion 21); specifically, located in the hollow portion. A peripheral edge portion of the inner top surface 35e has an annular flat surface. Also, the distal end portion 3e has an annular space which is defined by an inner lateral portion 37e, the inner top surface 35e, and the outer surface of the protruding portion 36e and whose diameter increases toward the lower side.

In this embodiment, the inner diameter of the annular breakable portion 5 as measured at its smallest diameter portion is greater than the maximum separation distance between the annular breakable portion 5 and the apex 38 of the protruding portion 36e. Therefore, at the time of opening operation, the protruding portion 36e does not interfere with the mouth portion 25 of the hollow portion 21. Namely, the protruding portion does not hinder the opening operation.

Specifically, as shown in FIG. 10, the shortest distance R1 between an outer edge point 51 of the breakable portion 5 and an inner surface point 52 which is located on the plane S (see FIG. 4) defined by the annular breakable portion 5 and is located on the side opposite the outer edge point 51 with respect to the center of the mouth portion 25 is longer than the maximum distance R2 between the outer edge point 51 of the breakable portion 5 and the apex 38 of the protruding portion 36e. Notably, preferably, the inner diameter of the annular breakable portion 5 as measured at its smallest diameter portion is greater than the maximum separation distance R2 between the annular breakable portion 5 and the apex 38 of the protruding portion 36e.

During the opening operation, the distal end portion 3e is pressed from the outer side of the inner surface point 52. As a result, breakage starts from that portion, and the distal end portion 3e rotates about the outer edge point 51 located on the side opposite the inner surface point 52. Consequently, the apex 38 of the protruding portion 36e approaches the inner surface point 52 at the edge of the mouth portion 25. In the case where, as described above, the maximum distance R2 between the outer edge point 51 of the breakable portion 5 and the apex 38 of the protruding portion 36e is smaller than the distance R1 between the outer edge point 51 and the inner surface point 52, the apex 38 passes through the mouth portion 25 without coming into contact with the inner surface of the mouth portion 25, and does not hinder the opening operation.

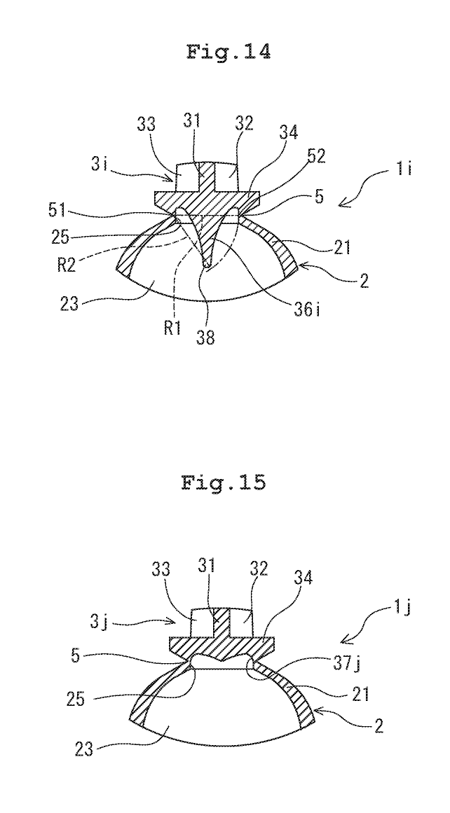

The shape of the outer surface of the protruding portion 36e is not limited to the above-described tapered shape for diameter reduction. For example, as in the case of a protruding portion 36i provided on a distal end portion 3i of the ampule 1i shown in FIG. 14, the protruding portion may have a curved outer surface. In the protruding portion 36i of this embodiment, its outer surface is curved inward (slightly concaved) as compared with the tapered outer surface. Notably, the outer surface of the protruding portion may be curved in the opposite direction; i.e., may be curved outward (bulge) as compared with the tapered outer surface.

In the ampule 1 of the present disclosure, the hollow portion 21 has the bottom surface portion 4 so as to stand without support. This bottom surface portion 4 allows the synthetic resin ampule 1 to stand without support in a state in which an upper portion of the hollow portion faces upward, and the tip of the distal end portion 3 faces upward. Preferably, the synthetic resin ampule 1 stably stands without support. However, the synthetic resin ampule 1 may swing or incline to some degree. In the case where the synthetic resin ampule 1 swings or inclines, preferably, the synthetic resin ampule 1 swings or inclines in a direction for the operation of breaking the breakable portion 5 which will be described later; i.e., in a first predetermined direction (X-direction) or a direction (Y-direction) opposite the first predetermined direction.

In this embodiment, the bottom surface portion 4 has an approximately flat bottom surface. Therefore, the synthetic resin ampule 1 stably stands without support such that the distal end portion 3 is approximately upright. Although approximately the entirety of the bottom surface of the bottom surface portion 4 is preferably flat, the bottom surface of the bottom surface portion 4 may have a concave central portion. Alternatively, the bottom surface portion 4 may have an annular protrusion which allows the ampule 1 to stand without support.

In the synthetic resin ampule 1 of this embodiment, the distal end portion 3 has a pressing portion for inducing pressing in a predetermined direction during the operation of breaking the breakable portion 5. The bottom surface portion 4 has extension portions 41 and 42 which extend in the predetermined direction (X-direction, Y-direction) in which the pressing is induced at the time of breaking operation of pressing portion 32 or 33.

In particular, in the ampule 1 of the embodiment shown in FIGS. 1 through 4, the distal end portion 3 includes a first pressing portion for inducing the pressing in the first predetermined direction (X-direction) for the operation of breaking the breakable portion 5, and a second pressing portion for inducing the pressing in the second predetermined direction (Y-direction) opposite the first predetermined direction. The bottom surface portion 4 has the extension portion 41 which extends in the predetermined direction (X-direction) in which the pressing is induced at the time of breaking operation of the first pressing portion, and further, the bottom surface portion 4 has the extension portion 42 which extends in the predetermined direction (Y-direction) in which the pressing is induced at the time of breaking operation of the second pressing portion.

In the ampule 1 of this embodiment, the distal end portion 3 includes a base portion 34, a plate-shaped main body portion 31 extending upward from the upper surface of the base portion 34, and a plurality of ribs 32 and 33 which are formed on opposite sides of the plate-shaped main body portion 31 to be perpendicular to the plate-shaped main body portion 31 and extend in the axial direction. The number of the ribs is preferably two or more and may be three or more. Notably, the ribs may be a plurality of ribs extending horizontally with respect to the plate-shaped main body portion.

The plurality of ribs 32 extending in the axial direction (vertical direction) are provided on one side of the plate-shaped main body portion 31, and the plurality of ribs 33 extending in the axial direction (vertical direction) are provided on the other side of the plate-shaped main body portion 31. The plurality (specifically, two) of ribs 32 constitute the first pressing portion for inducing the pressing in the first predetermined direction (X-direction) for the operation of breaking the breakable portion 5, and the plurality (specifically, two) of ribs 33 constitute the second pressing portion for inducing the pressing in the second predetermined direction (Y-direction) for the operation of breaking the breakable portion 5. The plurality of ribs 32 and 33 are not limited to those formed perpendicularly to the plate-shaped main body portion, and their direction, shape, number, etc. can be appropriately selected.

Specifically, as shown in FIGS. 1 and 2, the first pressing portion is formed by upper portions of the plurality of ribs 32 provided on the outer surface of the plate-shaped main body portion 31 and extending in the axial direction (vertical direction). The upper portions of the ribs 32 protrude from the plate-shaped main body portion 31 to have approximately the same height. Therefore, a user can adequately press the first pressing portion with his/her finger, so that the pressing direction coincides with a direction orthogonal to a surface (imaginary surface) formed by the first pressing portion. This direction is the first predetermined direction (X-direction). Therefore, when the first pressing portion is pressed with a finger or the like, the distal end portion 3 is pressed in the X-direction, and breakage of the breakable portion 5 starts at a position below the first pressing portion 31. As a result of progress of the breakage, the distal end portion 3 falls in the X-direction.

Also, as shown in FIGS. 2 through 4, the ribs 32 increase in protrusion length as extending downward from the pressing portion 31 and form a reinforcing portion for the entirety of the distal end portion 3.

At an upper portion of the distal end portion 3, the second pressing portion for inducing the pressing in the second predetermined direction (Y-direction) for the operation of breaking the breakable portion 5 is formed by the plurality of ribs 33. In the ampule 1 of this embodiment, the distal end portion 3 is configured such that the plurality of ribs 33 extending in the axial direction (vertical direction) are provided on the second pressing portion side as in the case of the first pressing portion side.

As shown in FIG. 2, the second pressing portion is formed by upper portions of the plurality of ribs 33 provided on the outer surface of the plate-shaped main body portion 31 and extending in the axial direction (vertical direction). The upper portions of the ribs 33 protrude from the plate-shaped main body portion 31 to have approximately the same height. Therefore, a user can adequately press the second pressing portion with his/her finger, so that the pressing direction coincides with a direction orthogonal to a surface (imaginary surface) formed by the second pressing portion. This direction is the second predetermined direction (Y-direction). Therefore, when the second pressing portion is pressed with a finger or the like, the distal end portion 3 is pressed in the Y-direction, and breakage of the breakable portion 5 starts at a position below the second pressing portion. As a result of progress of the breakage, the distal end portion 3 falls in the Y-direction.

Also, as shown in FIGS. 2 through 4, the ribs 33 increase in protrusion length as extending downward and form a reinforcing portion for the entirety of the distal end portion 3.

Notably, the pressing portion may be provided on one side only, and the pressing portion may be formed by a flat plate portion instead of the ribs as described above.

In the ampule 1 of the present disclosure, the ampule main body 2 has the extension portion 41 which extends in the predetermined direction (X-direction) in which the pressing is induced at the time of breaking operation of the first pressing portion, and the extension portion 42 which extends in the predetermined direction (Y-direction) in which the pressing is induced at the time of breaking operation of the second pressing portion.

The extension portions 41 and 42 are formed on the bottom surface portion of the ampule main body 2. In the ampule 1 of the embodiment shown in FIGS. 1 to 4, the bottom surface portion 4 is formed by the bottom plate member 40, and the extension portions are formed by the bottom plate member 40. As shown in FIG. 4, the bottom plate member 40 of this embodiment includes a plate-shaped bottom plate main body, and a tubular portion 43 extending upward from the upper surface of the bottom plate main body. The tubular portion 43 is fitted into a lower end opening 24 of the tubular body 20.

As shown in FIGS. 1 to 4, the bottom plate member 40, which forms the bottom surface portion 4, has the first extension portion 41 which extends outward (outward in the radial direction) from the lower end surface of the tubular body 20. This first extension portion 41 extends in the first predetermined direction (X-direction) in which the pressing is induced at the time of breaking operation of the first pressing portion. Therefore, when the first pressing portion (ribs 32) provided on the distal end portion is pressed in the induced pressing direction (X-direction) in a state in which the ampule stands without support, during the pressing, the extension portion 41 provided on the bottom surface portion 4 (bottom plate member 40) serves as a support, so that the pressing force applied to the pressing portion can be transmitted to the breakable portion without fail, and the breakable portion easily breaks.

In the ampule 1 of this embodiment, as shown in FIGS. 1 to 4, the bottom plate member 40, which forms the bottom surface portion 4, has the second extension portion 42 which extends outward (outward in the radial direction) from the lower end surface of the tubular body 20. The second extension portion 42 is provided on the side opposite the first extension portion 41. This second extension portion 42 extends in the second predetermined direction (Y-direction) in which the pressing is induced at the time of breaking operation of the second pressing portion. Therefore, when the second pressing portion (ribs 33) provided on the distal end portion is pressed in the induced pressing direction (Y-direction) in a state in which the ampule stands without support, during the pressing, the extension portion 42 provided on the bottom surface portion 4 (bottom plate member 40) serves as a support, so that the pressing force applied to the pressing portion (ribs 33) can be transmitted to the breakable portion without fail, and the breakable portion easily breaks.

Also, in the ampule 1 of this embodiment, as shown in FIGS. 1 to 4, the bottom plate member 40, which forms the bottom surface portion 4, has two additional extension portions 47 and 48 which extend outward (outward in the radial direction) from the lower end surface of the tubular body 20. In the ampule 1 of this embodiment, the extension portions 47 and 48 are provided on opposite sides. Also, the extension portions 47 and 48 are provided to be approximately orthogonal to an imaginary line connecting the extension portions 41 and 42. In the ampule 1 of this embodiment, the bottom surface portion 4 (bottom plate member 40) has a quadrilateral outer shape; specifically, an approximately square outer shape. Therefore, when the ampule 1 is fallen down, the rotation or rocking of the ampule is restrained.

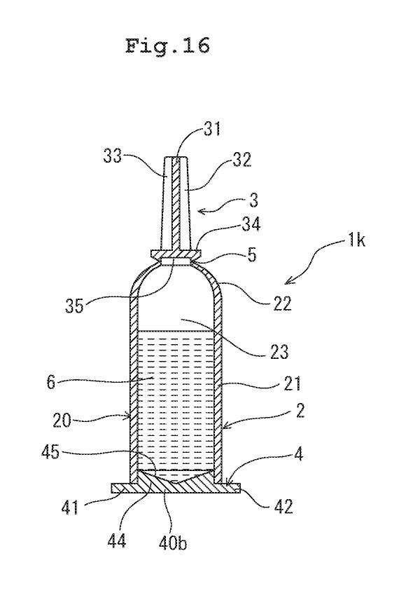

Also, in all the embodiments, as in the case of a bottom plate member 40b of an ampule 1k shown in FIG. 16, the bottom plate member may have a slanting upper surface 45 which slants toward the center of the bottom surface portion of the drug storing portion, the bottom surface portion being formed in the bottom plate member. The slanting upper surface 45 defines a conical space or a pyramidal space (hereinafter, the slanting upper surface 45 will be referred to as a “conical or pyramidal upper surface”). In this embodiment, the upper surface of an insertion portion 44 inserted into the tubular body has a conical upper surface (conical or pyramidal upper surface, funnel-shaped upper surface) 45 such that the diameter of the space defined by the conical upper surface decreases toward the center of the bottom plate member 40b. Notably, the conical or pyramidal upper surface may be a polygonal pyramidal upper surface. When such a conical or pyramidal upper surface is provided, at the end of an operation of taking the drug, the drug flows to the center of the conical or pyramidal upper surface 45. Therefore, the drug can be taken more reliably.

Next, other embodiments of the present disclosure will be described in detail with reference to the accompanying drawings.

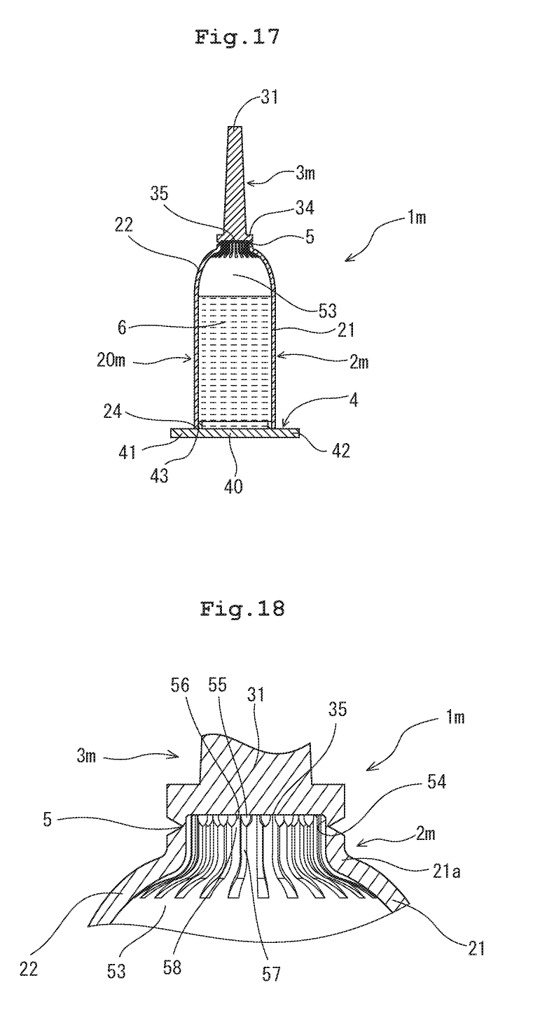

A drug-filled synthetic resin ampule 1m shown in FIGS. 17 and 18 includes an ampule main body 2m and a drug 6 stored in the ampule main body 2m. The ampule main body 2m includes a distal end portion 3m, a hollow portion 21 having a drug storing portion 53, and an annular breakable portion 5 provided between a lower portion of the distal end portion 3m and an upper portion of the hollow portion 21. The distal end portion 3m is configured such that an inner top surface 35 of the distal end portion 3m is located near a plane defined by the annular breakable portion 5. The inner top surface 35 has a flat surface. The ampule main body 2m has at least one rib 55 formed on an inner lateral portion 54 thereof which is located on the distal end portion side of the annular breakable portion 5. The inner surface of the distal end portion 3m is a low-drug-retention surface.

In particular, in the embodiment shown in FIG. 18, the ampule 1m includes the ampule main body 2m and the drug 6 stored in the ampule main body 2m. The ampule main body 2m includes the distal end portion 3m, the hollow portion 21 having the drug storing portion 53, and the annular breakable portion 5 provided between the lower portion of the distal end portion 3m and the upper portion of the hollow portion 21. The distal end portion 3m is configured such that the inner top surface 35 of the distal end portion 3m is located near the plane defined by the annular breakable portion 5. The inner top surface 35 is flat. The ampule main body 2m has a plurality of micro-ribs 55 formed on an inner lateral portion 54 thereof which is located on the distal end portion side of the annular breakable portion 5. The inner surface of the distal end portion 3m is a low-drug-retention surface.

The ampule 1m of this embodiment differs from the above-described ampule 1 in the shape of the inner surface of the inner upper portion. The distal end portion 3m of the ampule 1m may have the same lower portion shape as that in the ampule 1 and the same outer surface shape of the distal end portion 3 as that in the ampule 1.

As shown in FIG. 17, the synthetic resin ampule 1m of this embodiment includes the ampule main body 2m and the drug 6 stored in the ampule main body 2m. The above-described drug is stored as the drug 6.

As in the case of the ampule main body 2 shown in FIGS. 1 to 4, the ampule main body 2m can stand without support as shown in FIG. 17. The ampule main body 2m includes a tubular body 20m and a bottom plate member 40 which seals a lower end opening of the tubular body 20m. The tubular body 20m includes the hollow portion 21, the distal end portion 3m, and the breakable portion 5.

The tubular body 20m is the same as the above-described tubular body 20m except for the shape of the inner surface of the upper portion thereof. The tubular body 20m includes the hollow portion 21 having a lower end opening and extending upward; the distal end portion 3m located above the hollow portion; and the breakable portion 5 which is provided between the lower portion of the distal end portion 3m and the upper portion of the hollow portion 21; in other words, provided to form a boundary between the distal end portion 3m and the hollow portion 21. The hollow portion 21 has the drug storing portion 53. Preferably, the drug storing portion 53 has a volume of about 0.5 to 50 ml. As shown in FIG. 17, the hollow portion 21 has a cylindrical portion which extends over a predetermined length while maintaining approximately constant outer and inner diameters, and an inner surface tapered portion located at an upper portion of the cylindrical portion.

The tubular body 20m can be molded by injection molding. For example, after the tubular main body portion including the hollow portion 21 is molded by injection molding, the breakable portion 5 may be attached thereto by ultrasonic welding or high-frequency welding. Alternatively, the entire tubular body 20m including the breakable portion 5 may be formed by injection molding. The bottom surface portion 4 may be integrally molded when the tubular body 20m or the tubular main body portion including the hollow portion 21 is molded. Alternatively, like the breakable portion 5, the bottom surface portion 4 may be attached to the tubular body 20m later on by, for example, ultrasonic welding or high-frequency welding.

The inner diameter of the cylindrical portion is preferably 6 to 33 mm, particularly preferably 7 to 24 mm. The outer diameter of the cylindrical portion is preferably 7 to 35 mm, particularly preferably 10 to 25 mm. The inner diameter of the tapered portion 22 at a small diameter portion thereof is preferably 3 to 12 mm, particularly preferably 3 to 9 mm.

Preferably, the hollow portion (the drug storing portion 53) of the tubular body 20m is formed to be transparent so that the stored drug can be visually observed. The internal pressure of the drug storing portion 53 of the tubular body 20m may be the normal pressure. Alternatively, the drug storing portion 53 may be brought into a pressure reduced or vacuum state. In the case where the drug storing portion is in a pressure reduced or vacuum state, the effect of preventing degeneration, decomposition, degradation, etc. of the drug is improved.

The breakable portion 5 is the same as that described in relation to the ampule 1.

The distal end portion 3m forms an upper end of the ampule main body 2m and is located above the tubular body 20m. As shown in FIG. 17, the distal end portion 3m has the inner top surface 35. The inner top surface 35 of the distal end portion 3m is located near the plane S defined by the annular breakable portion 5. In the ampule 1m of this embodiment, the plane S defined by the annular breakable portion 5 and the inner top surface 35 of the distal end portion 3m are spaced from each other by a predetermined distance W. Preferably, the distance W is as close to 0 mm as possible.

Also, the ampule main body 2m; specifically, the distal end portion 3m, has a plurality of micro-ribs 55 on its inner lateral portion located on the distal end portion side (top surface side) of the annular breakable portion 5. Recesses 56 are formed between the micro-ribs 55. The plurality of micro-ribs 55 decrease the amount of the drug remaining on the inner lateral portion on the distal end portion side (top surface side) of the annular breakable portion 5. Each of the micro-ribs 55 preferably has a width of about 1 μm to 6 mm and a height of about 1 μm to 3.3 mm.

In the ampule 1m of this embodiment, a large number of axial ribs 57 extending in the vertical direction are provided on the inner surface of an upper portion of the ampule main body 2m. Also, grooves 58 extending in the vertical direction (axial direction) are formed between the ribs 57. The upper ends of the ribs 57 are located at the inner top surface 35 of the distal end portion 3m or the above-described micro-ribs 55. The ribs 57 extend downward beyond the region where the breakable portion 5 is formed and an upper bent portion 21a, and their lower ends are located at the tapered portion 22 of the ampule main body 2m. Each rib 57 has, at its lower end portion, a slant surface whose protrusion height decreases gradually toward the lower end. Since the axial ribs 57 and the axially extending grooves 58 formed between the ribs are provided, the drug adhering to the upper portion of the hollow portion 21 of the ampule main body 2m easily flows into the lower portion of the hollow portion 21.

Each of the axial ribs 57 preferably has a width of about 1 μm to 6 mm and a height of about 1 μm to 3.3 mm.

Also, as shown in FIG. 17, a lower inside portion (inner lateral portion) 54 of the distal end portion 3m has a short hollow portion which extends from the inner surface of the annular breakable portion 5 to a corner portion of the inner top surface 35 while maintaining an approximately constant inner diameter. As shown in FIG. 17, the corner portion of the inner top surface 35 of the distal end portion 3m has a curved surface having no edge. The distal end portion 3m is solid in a region above the inner top surface 35. Notably, the distal end portion 3m may have a cavity.

The inner surface of the distal end portion 3m is a low-drug-retention surface. In the ampule 1m of this embodiment, since the inner top surface 35 of the distal end portion 3m is flat, in cooperation with the above-described form of the side surface, the inner top surface 35 serves as a low-drug-retention surface. Preferably, the inner surface (the side surface and the top surface) of the distal end portion 3m is a water repellent surface. This restrains adhesion of the drug. The water repellent surface may be the inner surface of the distal end portion itself when the distal end portion is made of a resin having water repellency. Alternatively, the water repellent surface may be formed by providing a film of a water repellent substance on the inner surface of the distal end portion. The water-repellent film may be formed by coating the inner surface of the distal end portion with a water-repellent coating material and hardening the coating material.

The water-repellent film may be provided on the entire inner surface of the hollow portion 21, and further provided on the entire inner surface of the ampule main body 2m, including the upper surface of the bottom surface portion 4, which will be described later. As the water-repellent film, the water-repellent film described in relation to the ampule 1 can be used appropriately.

Also, as in ampules 1b to 1j shown in FIGS. 7 to 15, the distal end portion 3m may have a protruding portion which is provided at a central portion of the inner top surface and which protrudes in a direction toward the hollow portion (a direction toward a central portion of the bottom surface portion 4). When such a protruding portion is provided, the volume of the drug retainable portion of the distal end portion decreases. Also, before the ampule is opened, the drug adhering to the inner surface of the distal end portion is easily caused to drop into the hollow portion by applying a vibration to the distal end portion by, for example, tapping the distal end portion.

In the synthetic resin ampule lm of this embodiment as well, as in the case of the above-described ampule 1, the distal end portion 3m preferably has a pressing portion for inducing pressing in the predetermined direction at the time of the operation of breaking the breakable portion 5. The bottom surface portion 4 preferably has extension portions 41 and 42 which extend in the predetermined direction (X-direction, Y-direction) in which the pressing is induced at the time of breaking operation of the pressing portions 32 or 33.

In particular, as in the case of the above-described ampule 1 of the embodiment shown in FIGS. 1 through 4, the distal end portion 3m preferably includes a first pressing portion for inducing the pressing in the first predetermined direction (X-direction) for the operation of breaking the breakable portion 5, and a second pressing portion for inducing the pressing in the second predetermined direction (Y-direction) opposite the first predetermined direction. The bottom surface portion 4 preferably has the extension portion 41 which extends in the predetermined direction (X-direction) in which the pressing is induced at the time of breaking operation of the first pressing portion, and further, the bottom surface portion 4 has the extension portion 42 which extends in the predetermined direction (Y-direction) in which the pressing is induced at the time of breaking operation of the second pressing portion. The pressing portions and the extension portions are preferably the same as those described in relation to the ampule 1.

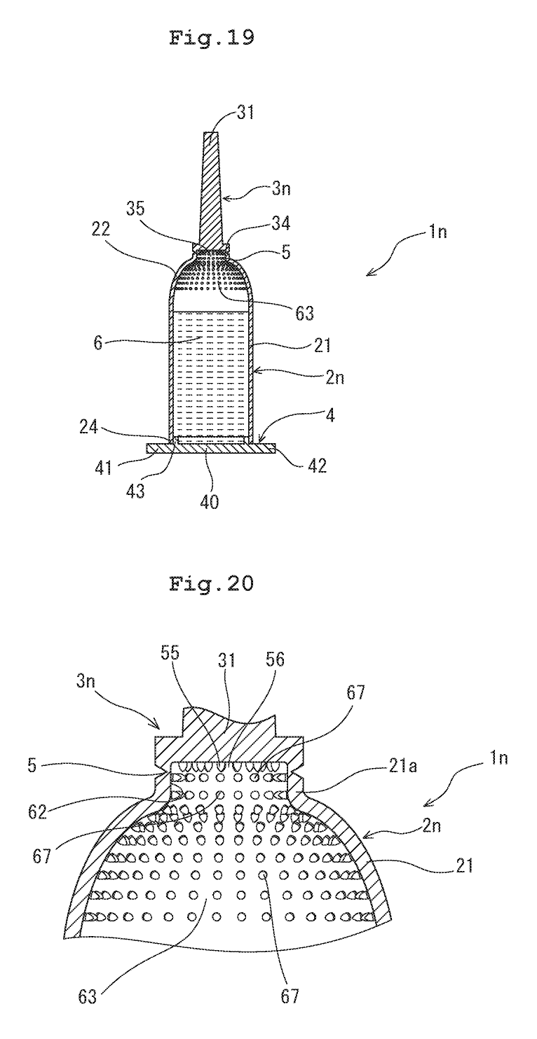

Also, the shape of the inner surface of the upper portion of the drug storing portion of the ampule may be the same type as that of the inner surface of the upper portion of the drug storing portion of a drug-filled synthetic resin ampule 1n shown in FIGS. 19 and 20. The ampule 1n includes an ampule main body 2n. The distal end portion 3n of the ampule main body 2n has a plurality of micro-ribs 55 on its inner lateral portion located on the distal end portion side (top surface side) of the annular breakable portion 5. Recesses 56 are formed between the micro-ribs 55. The plurality of micro-ribs decrease the amount of the drug remaining on the inner lateral portion on the distal end portion side (top surface side) of the annular breakable portion 5. The micro-ribs 55 and the recesses 56 are the same as those described in relation to the ampule 1m. The distal end portion 3n of the ampule 1n may have the same lower portion shape as that in the ampule 1 and the same outer surface shape of the distal end portion 3 as that in the ampule 1.

Further, in the ampule 1n of this embodiment, a plurality of protrusions 67 are provided on the inner surface 62 of an upper portion of the ampule main body 2n. Each protrusion 67 has a proximal end on the inner surface of the upper portion of the ampule main body 2n and decreases in diameter toward the distal end thereof. In particular, in this embodiment, each protrusion 67 has a bullet-like shape. The protrusions 67 are formed in a region where the breakable portion 5 is formed and an inner surface region 63 which extends therefrom beyond the upper bent portion 21a. Since a large number of such protrusions 67 are provided, the drug adhering to the upper portion of the hollow portion 21 of the ampule main body 2n easily flows into the lower portion of the hollow portion 21.

Each of the protrusions 67 preferably has an outer diameter of about 1 μm to 6 mm at the bottom surface and a height of about 1 μm to 3.3 mm.

The drug-charged synthetic resin-made ampule of the present disclosure, which is filled with the drug and hermetically sealed, is autoclave sterilized. Particularly preferably, the ampule is autoclave sterilized at a temperature of 120° C. or higher. Specifically, the ampule is preferably autoclave sterilized under overkill conditions (ISO/TS 17665-2) (i.e., at 121 degree C. for 15 minutes).

The drug-charged synthetic resin-made ampule main body (tubular main body and bottom plate member) is preferably formed of a material that can be subjected to autoclave sterilization, particularly preferably a material that can be adapted to the aforementioned overkill conditions (ISO/TS 17665-2). Specific examples of the material for forming the ampule main body include hard polyvinyl chloride; polyolefins, such as polyethylene, polypropylene, polybutadiene, cyclic polyolefins (e.g., ZEONEX (manufactured by Zeon Corporation) and APEL (manufactured by Mitsui Chemicals, Inc.)), polypropylene homopolymer, and high-density polyethylene; polystyrene; poly-(4-methylpentene-1); polycarbonate; ABS resin; acrylic resin; polymethyl methacrylate (PMMA); polyacetal; polyarylate; polyacrylonitrile; polyvinylidene fluoride; ionomers; acrylonitrile-butadiene-styrene copolymers; polyesters, such as polyethylene terephthalate (PET) and polybutylene terephthalate (PBT); butadiene-styrene copolymers; resins, such as aromatic and aliphatic polyamides; and any combination of these.

As described above, the synthetic resin-made ampule body is formed by means of injection molding. Thus, the ampule is preferably formed of any hard resin material suitable for injection molding.

A drug-filled synthetic resin ampule of the present disclosure is as follows.
(1) A drug-filled synthetic resin ampule comprising

an ampule main body and a drug stored in said ampule main body;

wherein said ampule main body includes a distal end portion, a hollow portion having a drug storing portion, and an annular breakable portion provided between a lower portion of said distal end portion and an upper portion of said hollow portion;

said ampule main body includes no inner lateral surface protrusion on an inner lateral portion thereof which is located on a side toward said distal end portion with respect to said annular breakable portion; and

said distal end portion is configured such that an inner top surface of said distal end portion is located near a plane defined by said annular breakable portion and an inner surface of said distal end portion is a low-drug-retention surface.

In the above-described synthetic resin ampule, the ampule main body does not have an inner lateral surface protrusion on the side toward the distal end portion with respect to the annular breakable portion, and the distal end portion is configured such that the inner top surface of the distal end portion is located near the plane defined by the annular breakable portion. Thus, the drug retainable portion of the distal end portion is very small. Therefore, even when an operation of opening the ampule is performed after the ampule has been brought into an inclined state, substantially no drug remains in the separated distal end portion. Further, since the inner surface of the distal end portion is a low-drug-retention surface, the drug does not adhere to the inner surface of the separated distal end portion, and the amount of the drug which scatters at the time of opening is extremely small.

Also, the drug-filled synthetic resin ampule may be embodied as follows.
(2) A drug-filled synthetic resin ampule according to the above (1), wherein said distal end portion includes a protruding portion which is formed at a central portion of said inner top surface and protrudes toward said hollow portion.
(3) A drug-filled synthetic resin ampule according to the above (2), wherein said distal end portion includes an annular space defined by said inner top surface and an outer circumference of an upper portion of said protruding portion.
(4) A drug-filled synthetic resin ampule according to the above (2) or (3), wherein a diameter of said annular breakable portion as measured at its smallest diameter portion is greater than a maximum separation distance between said annular breakable portion and an apex of said protruding portion.

(5) A drug-filled synthetic resin ampule according to any one of the above (1) to (4), wherein a corner portion of said inner top surface is a curved surface having no edge.
(6) A drug-filled synthetic resin ampule according to any one of the above (1) to (5), wherein said ampule includes a hollow portion which extends from an inner surface of said annular breakable portion to a corner portion of said inner top surface while maintaining an approximately constant inner diameter or a hollow portion which extends from said inner surface of said annular breakable portion to said corner portion of said inner top surface while decreasing its diameter toward said inner top surface.

(7) A drug-filled synthetic resin ampule according to any one of the above (1) to (6), wherein said inner top surface is a water repellent surface.

(8) A drug-filled synthetic resin ampule according to any one of the above (1) to (7), wherein a portion of said ampule main body which is located above said breakable portion and which includes said distal end portion cannot retain said drug.

(9) A drug-filled synthetic resin ampule according to any one of the above (1) to (8), wherein said ampule main body includes a bottom plate member which seals a lower end opening of said hollow portion.

(10) A drug-filled synthetic resin ampule according to the above (9), wherein said bottom plate member has a conical or pyramidal upper surface which inclines toward a center of a bottom surface portion of said drug storing portion, said bottom surface portion being formed in said bottom plate member.

Another drug-filled synthetic resin ampule of the present disclosure is as follows.
(11) A drug-filled synthetic resin ampule comprising

an ampule main body and a drug stored in said ampule main body;

wherein said ampule main body includes a distal end portion, a hollow portion having a drug storing portion, and an annular breakable portion provided between a lower portion of said distal end portion and an upper portion of said hollow portion; and

said distal end portion is configured such that an inner top surface of said distal end portion is located near a plane defined by said annular breakable portion, said inner top surface has a flat surface, said ample main body includes ribs which are formed on its inner lateral portion located on a side toward said distal end portion with respect to said annular breakable portion, and an inner surface of said distal end portion is a low-drug-retention surface.

Also, the drug-filled synthetic resin ampule may be embodied as follows.
(12) A drug-filled synthetic resin ampule according to the above (11), wherein a corner portion of said inner top surface is a curved surface having no edge.
(13) A drug-filled synthetic resin ampule according to the above (11) or (12), wherein said inner top surface is a water repellent surface.
(14) A drug-filled synthetic resin ampule according to any one of the above (11) to (13), wherein a portion of said ampule main body which is located above said breakable portion and which includes said distal end portion cannot retain said drug.
(15) A drug-filled synthetic resin ampule according to any one of the above (11) to (14), wherein said ampule main body includes a bottom plate member which seals a lower end opening of said hollow portion.

Another drug-filled synthetic resin ampule of the present disclosure is as follows.
(16) A drug-filled synthetic resin ampule comprising

an ampule main body and a drug stored in said ampule main body;

wherein said ampule main body includes a distal end portion, a hollow portion having a drug storing portion, and an annular breakable portion provided between a lower portion of said distal end portion and an upper portion of said hollow portion;

said distal end portion is configured such that an inner top surface of said distal end portion is located near a plane defined by said annular breakable portion and an inner surface of said distal end portion is a water repellent surface,

said distal end portion includes a protruding portion which is formed at a central portion of said inner top surface and protrudes toward said hollow portion, and an annular space defined by said inner top surface and an outer circumference of an upper portion of said protruding portion, and

a diameter of said annular breakable portion as measured at its smallest diameter portion is greater than a maximum separation distance between said annular breakable portion and an apex of said protruding portion.

What is claimed is:

1. A drug-filled synthetic resin ampule comprising an ampule main body and a drug stored in said ampule main body;
wherein said ampule main body includes a distal end portion, a hollow portion having a drug storing portion, and an annular breakable portion provided between a lower portion of said distal end portion and an upper portion of said hollow portion;
said ampule main body includes no inner lateral surface protrusion on an inner lateral portion thereof which is located on a side toward said distal end portion with respect to said annular breakable portion; and
said distal end portion is configured such that an inner top surface of said distal end portion is located near a plane defined by said annular breakable portion and an inner surface of said distal end portion is a low-drug-retention surface.

2. A drug-filled synthetic resin ampule according to claim 1, wherein said distal end portion includes a protruding portion which is formed at a central portion of said inner top surface and protrudes toward said hollow portion.

3. A drug-filled synthetic resin ampule according to claim 2, wherein said distal end portion includes an annular space defined by said inner top surface and an outer circumference of an upper portion of said protruding portion.

4. A drug-filled synthetic resin ampule according to claim 2, wherein a diameter of said annular breakable portion as measured at its smallest diameter portion is greater than a maximum separation distance between said annular breakable portion and an apex of said protruding portion.

5. A drug-filled synthetic resin ampule according to claim 1, wherein a corner portion of said inner top surface is a curved surface having no edge.

6. A drug-filled synthetic resin ampule according to claim 1, wherein said ampule includes a hollow portion which extends from an inner surface of said annular breakable portion to a corner portion of said inner top surface while maintaining an approximately constant inner diameter or a hollow portion which extends from said inner surface of said annular breakable portion to said corner portion of said inner top surface while decreasing its diameter toward said inner top surface.

7. A drug-filled synthetic resin ampule according to claim 1, wherein said inner top surface is a water repellent surface.

8. A drug-filled synthetic resin ampule according to claim 1, wherein a portion of said ampule main body which is located above said breakable portion and which includes said distal end portion cannot retain said drug.

9. A drug-filled synthetic resin ampule according to claim 1, wherein said ampule main body includes a bottom plate member which seals a lower end opening of said hollow portion.

10. A drug-filled synthetic resin ampule according to claim 9, wherein said bottom plate member has a conical or pyramidal upper surface which inclines toward a center of a bottom surface portion of said drug storing portion, said bottom surface portion being formed in said bottom plate member.

11. A drug-filled synthetic resin ampule comprising
an ampule main body and a drug stored in said ampule main body;
wherein said ampule main body includes a distal end portion, a hollow portion having a drug storing portion, and an annular breakable portion provided between a lower portion of said distal end portion and an upper portion of said hollow portion; and
said distal end portion is configured such that an inner top surface of said distal end portion is located near a plane defined by said annular breakable portion, said inner top surface has a flat surface, said ample main body includes ribs which are formed on its inner lateral portion located on a side toward said distal end portion with respect to said annular breakable portion, and an inner surface of said distal end portion is a low-drug-retention surface.

12. A drug-filled synthetic resin ampule according to claim 11, wherein a corner portion of said inner top surface is a curved surface having no edge.

13. A drug-filled synthetic resin ampule according to claim 11, wherein said inner top surface is a water repellent surface.

14. A drug-filled synthetic resin ampule according to claim 11, wherein a portion of said ampule main body which is located above said breakable portion and which includes said distal end portion cannot retain said drug.

15. A drug-filled synthetic resin ampule according to claim 11, wherein said ampule main body includes a bottom plate member which seals a lower end opening of said hollow portion.

16. A drug-filled synthetic resin ampule comprising
an ampule main body and a drug stored in said ampule main body;
wherein said ampule main body includes a distal end portion, a hollow portion having a drug storing portion, and an annular breakable portion provided between a lower portion of said distal end portion and an upper portion of said hollow portion;
said distal end portion is configured such that an inner top surface of said distal end portion is located near a plane defined by said annular breakable portion and an inner surface of said distal end portion is a water repellent surface,
said distal end portion includes a protruding portion which is formed at a central portion of said inner top surface and protrudes toward said hollow portion, and an annular space defined by said inner top surface and an outer circumference of an upper portion of said protruding portion, and
a diameter of said annular breakable portion as measured at its smallest diameter portion is greater than a maximum separation distance between said annular breakable portion and an apex of said protruding portion.
